(19) United States
(12) Patent Application Publication
(10) Pub. No.: US 2018/0326870 A1
(43) Pub. Date: Nov. 15, 2018

(54) VEHICLE CHILD SAFETY SYSTEM

(71) Applicant: PIERRE-RICHARD PRESNA, Bridgeport, CT (US)

(72) Inventor: PIERRE-RICHARD PRESNA, Bridgeport, CT (US)

(21) Appl. No.: 15/590,339

(22) Filed: May 9, 2017

(51) Int. Cl. B60N 2/00; G08B 21/02; G08B 21/22; B60N 2/28; B60R 22/18

(52) U.S. Cl. CPC B60N 2/002; G08B 21/0205; G07C 2009/00984; B60N 2/28; B60R 22/18; G08B 21/22

(57) ABSTRACT

The vehicle child safety system is a safety system that is configured for use in a vehicle. The vehicle child safety system is configured for use with a child safety seat. The vehicle child safety system: 1) determines whether the child safety seat is installed within the vehicle; 2) determines whether the child safety seat is occupied; 3) requires the operator to acknowledge the presence of the child safety seat before the operation of the vehicle; 4) monitors the location of the key fob relative to the vehicle. If it is determined: 1) that the key fob is external to the vehicle; and, 2) that the child safety seat is occupied; then, 3) the vehicle child safety system activates the horn and alarm flashes the exterior lights; and, 4) sends a message informing an appropriate authority that

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of transporting including vehicle passenger accommodations not otherwise provided for, more specifically, a seat specially adapted for a vehicle with a passenger detection system.

### SUMMARY OF INVENTION

The vehicle child safety system is a safety system that is configured for use in a vehicle. The vehicle is further defined with a key fob, a horn, and exterior lights. The vehicle child safety system is configured for use with a child safety seat installed within the vehicle. The vehicle child safety system: 1) determines whether the child safety seat is installed within the vehicle; 2) determines whether the child safety seat is occupied; 3) requires an operator of the vehicle to physically operation of the vehicle is permitted; 4) monitors the location of the key fob relative to the vehicle. If it is determined that: 1) the key fob is located at a position external to the vehicle; and, 2) that the child safety seat is occupied; then, 3) the vehicle child safety system activates the horn; 4) the vehicle child safety system flashes the exterior lights; and, 5) sends a message over a commercially provided and publicly available cellular wireless network informing an appropriate authority that a passenger remains in an otherwise unattended vehicle.

These together with additional objects, features and advantages of the vehicle child safety system will be readily apparent to those of ordinary skill in the art upon reading the following detailed description of the presently preferred, but nonetheless illustrative, embodiments when taken in conjunction with the accompanying drawings.

In this respect, before explaining the current embodiments of the vehicle child safety system in detail, it is to be understood that the vehicle child safety system is not limited in its applications to the details of construction and arrangements of the components set forth in the following description or illustration. Those skilled in the art will appreciate that the concept of this disclosure may be readily and systems for carrying out the several purposes of the vehicle child safety system.

It is therefore important that the claims be regarded as including such equivalent construction insofar as they do not depart from the spirit and scope of the vehicle child safety system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is an in use view of an embodiment of the disclosure.

FIG. 3 is a block diagram of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

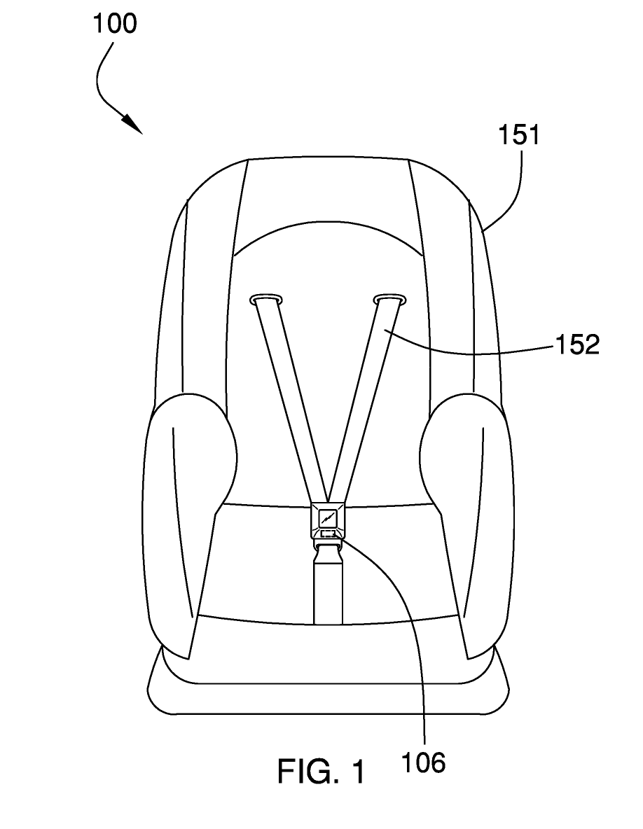

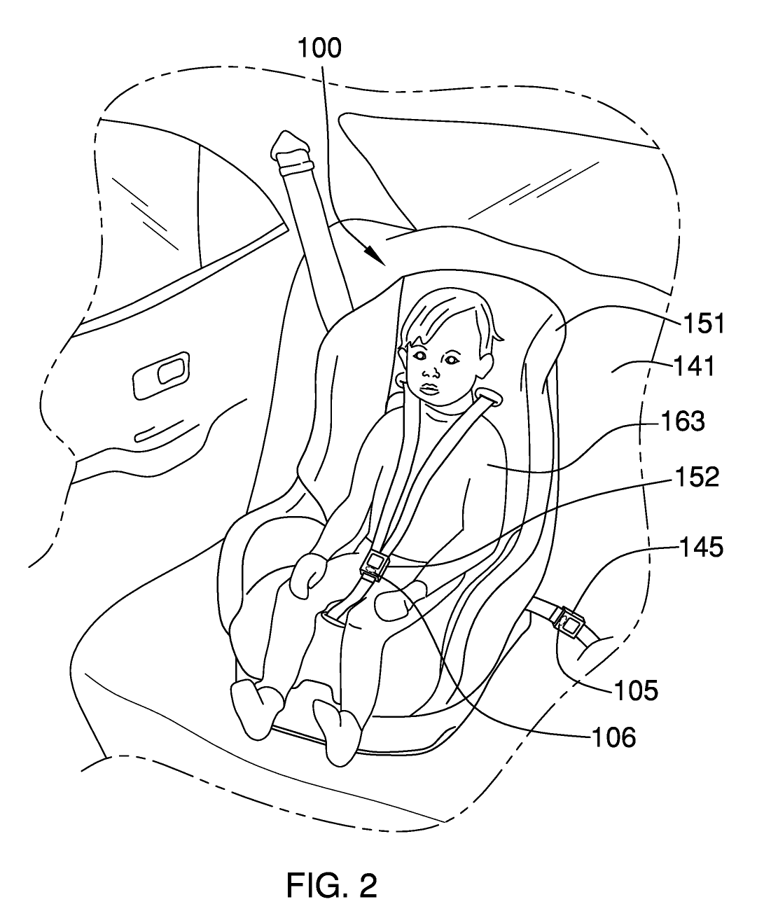

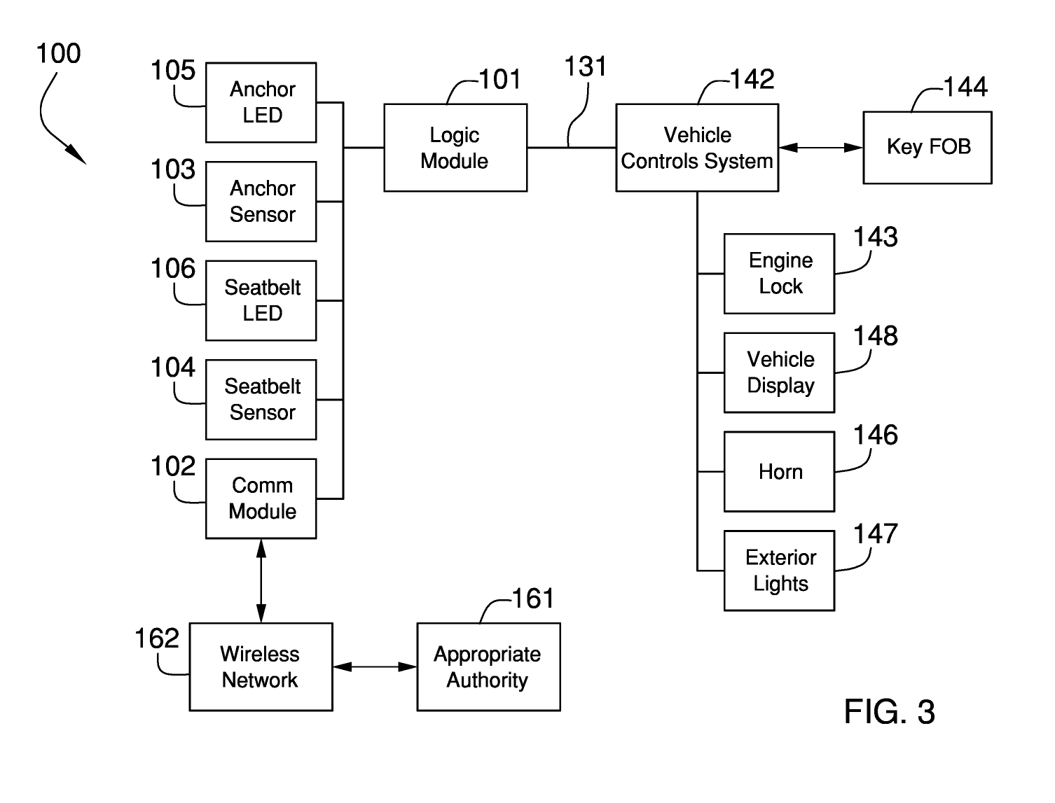

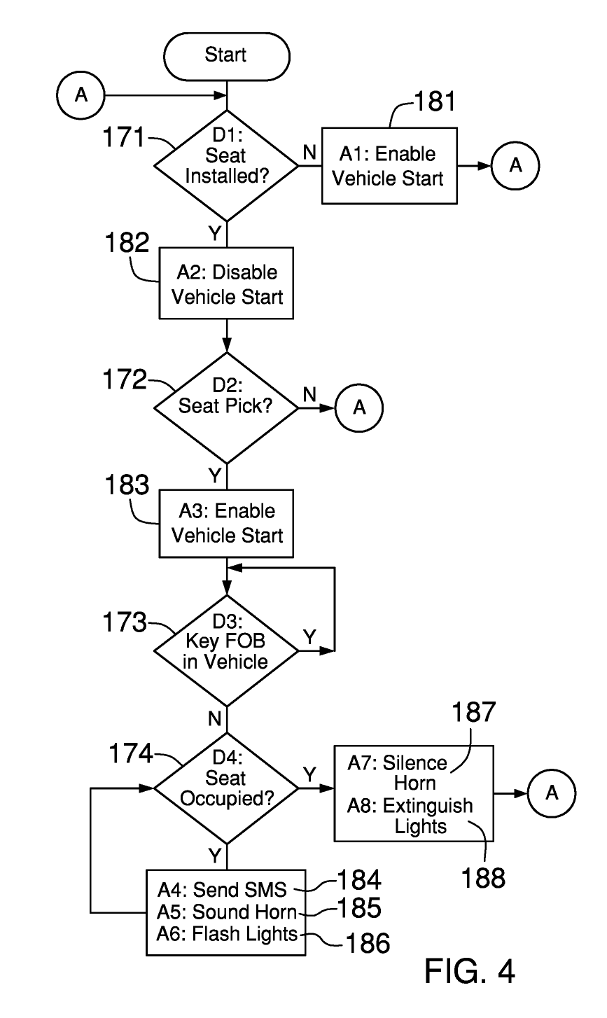

Detailed reference will now be made to one or more potential embodiments of the disclosure, which are illustrated in FIGS. 1 through 4.

The vehicle child safety system 100 (hereinafter invention) is a safety system that is configured for use in a vehicle 141. The vehicle 141 is further defined with a vehicle 141 control system 142, a vehicle 141 seat belt 145, a vehicle 141 horn 146, and vehicle 141 exterior lights 147. The vehicle 141 control 143, a vehicle 141 key fob 144, and a vehicle 141 display 148. The invention 100 is configured for use with a child safety seat 151 installed within the vehicle 141. The child safety seat 151 is further defined with a child safety seat 151 belt 152. The invention 100: 1) determines whether the child safety seat 151 is installed within the vehicle 141; 2) determines whether the child safety seat 151 is occupied by a passenger 163; 3) requires an operator of the vehicle 141 to physically acknowledge the presence of the child safety seat 151 before the operation of the vehicle 141 is permitted; 4) monitors the location of the vehicle 141 key fob 144 relative to the vehicle 141. If it is determined that: 1) the vehicle 141 key fob 144 is located at a position external to the vehicle 141; and, 2) that the child safety seat 151 is occupied; then, 3) the invention 100 activates the vehicle 141 horn 146; 4) the invention 100 flashes the vehicle 141 exterior lights 147; and, 5) the invention 100 sends a message over a commercially provided and publicly available cellular wireless network 162 informing an appropriate authority 161 that the passenger 163 remains in an otherwise unattended vehicle 141.

The invention 100 comprises a logic module 101, a communication module 102, an anchor sensor 103, a seat belt sensor 104, an anchor LED 105, and a seat belt LED 106. The sensor 103, the seat belt sensor 104, the anchor LED 105, the seat belt LED 106, and the vehicle 141 control system 142 are electrically interconnected.

The vehicle 141 is assumed to be, but does not have to be, an automobile. The vehicle 141 control system 142 is an electronic device that is used to monitor and control the operation of the electronics associated with the vehicle 141. The vehicle 141 control system 142 exchanges information with the logic module 101 through an interface 131. Methods to design, implement and install an interface 131 between a logic module 101 and a vehicle 141 control system 142 are well known and documented in the electrical arts.

The vehicle 141 engine lock 143 is a functionality contained within the vehicle 141 control system 142 of the vehicle 141. The status of the vehicle 141 engine lock 143 can be shared with and changed by the logic module 101 using the interface 131. The vehicle 141 key fob 144 is a domestic article that further comprises an electronic device that is monitored by the vehicle 141 control system 142. Specifically the vehicle 141 control system 142 monitors the location of the vehicle 141 key fob 144. The location of the vehicle 141 key fob 144 is shared by the vehicle 141 control system 142 with the

The vehicle 141 seat belt 145 is a well-known safety device provisioned by the vehicle 141 that is used to anchor the child safety seat 151 within the vehicle 141. The vehicle 141 horn 146 is an audible alarm that is provisioned with the vehicle 141. The vehicle 141 exterior lights 147 refers to the externally visible running lights that are required for the safe operation of the vehicle 141 and that are provisioned with the vehicle 141. The vehicle 141 display 148 is a visual computer display panel that provides an interface 131 between the operator of the vehicle 141 and the vehicle 141 control system 142.

The child safety seat 151 is a well-known seating system that: 1) is anchored into the vehicle 141; and, 2) is readily and commercially available. The child safety seat 151 belt 152 is a well-known safety device provisioned with the child safety seat 151. The passenger 163 refers to the occupant of the child safety seat 151.

The invention 100 is intended for manufacture as a single integrated unit that is custom built for its purpose. While the invention 100 is intended to be manufactured as a single unit, the invention 100 will be described under the assumption that the invention 100 is formed as a modification to an existing child safety seat 151 that is commercially available. This clarity of exposition of the disclosure and is not intended to limit the scope of the appended claims. Those skilled in the art will recognize that the invention 100 can be formed using either method with a minimum of modification and experimentation.

The logic module 101 is a readily and commercially available programmable electronic device that is used to manage, regulate, and operate the invention 100. The communication module 102 is a readily and commercially available wireless electronic communication device that allows the logic module 101 to communicate to an appropriate authority 161 using a wireless technology.

In the first potential embodiment of the disclosure, communication module 102 communicates SMS and MMS messages between the logic module 101 and the appropriate authority 161 through a commercially provided and publicly available cellular wireless network 162. The use of a commercially provided and publicly available cellular wireless network 162 is preferred because: 1) of its low cost; 2) of its widespread availability and broad interoperability between competing commercially provided and publicly available cellular wireless networks 162; and, 3) methods and techniques to send SMS and MMS messages over network 162 are well known and documented by those skilled in the electrical arts.

Within this disclosure, the commercially provided and publicly available cellular wireless network 162 refers to a wireless communication company that supports SMS and MMS messaging.

The anchor sensor 103 is a first switch that is monitored by the logic module 101. The anchor sensor 103 is installed in the vehicle 141 seat belt 145 such that the opening and the closing of the vehicle 141 seat belt 145 actuates the switch that forms the anchor sensor 103. The logic module 101 senses the actuation position of the switch within the anchor sensor 103 to determine whether the child safety seat 151 is installed in the vehicle 141. The anchor sensor 103 is installed in the vehicle 141 seat belt 145 that is used to anchor the child safety seat 151 into the vehicle 141.

The anchor LED 105 is a light emitting diode that is: 1) mounted in the proximity of the vehicle 141 seat belt 145; and, 2) controlled by the logic module 101. The logic module 101 illuminates the anchor LED 105 when the logic module 101 detects that the vehicle 141 seat belt 145 is latched and in use

The seat belt sensor 104 is a second switch that is monitored by the logic module 101. The seat belt sensor 104 is opening and the closing of the child safety seat 151 belt 152 actuates the switch that forms the seat belt sensor 104. The logic module 101 senses the actuation position of the switch within the seat belt sensor 104 to determine whether the passenger 163 is sitting in the child safety seat 151. The seat belt sensor 104 is installed in the child safety seat 151 belt 152 that is used to anchor the passenger 163 into the child safety seat 151.

The seat belt LED 106 is a light emitting diode that is: 1) mounted in the proximity of the child safety seat 151 belt 152; and, 2) controlled by the logic module 101. The logic module 101 illuminates the seat belt LED 106 when the logic module 101 detects that the child safety seat 151 belt 152 is latched and in use

The operation of the invention 100 is described in the following 8 paragraphs and illustrated in FIG. 4.

The logic module 101 makes a first decision 171 to determine whether the child safety seat 151 is installed in the vehicle 141 by checking the switch actuation position of the anchor LED 105. If the child safety seat 151 is not installed in the vehicle 141 then the logic module 101 takes a first action 181.

The first action 181 entails the logic module 101 sending a message over the interface 131 to the vehicle 141 control system 142 requesting that the vehicle 141 engine lock 143 be disabled thereby allowing the vehicle 141 to be started. The logic module 101 then loops back to the vehicle 141.

If the child safety seat 151 is installed in the vehicle 141 then the logic module 101 takes a second action 182. The second action 182 entails the logic module 101 sending a message over the interface 131 to the vehicle 141 control system 142 requesting that the vehicle 141 engine lock 143 be enabled thereby preventing the vehicle 141 from starting.

The logic module 101 then makes a second decision 172 to determine whether the operator of the vehicle 141 has acknowledged the presence of the child safety seat 151 in the vehicle 141. The acknowledgement procedure required by the second decision 172 entails the operator responding to a challenge informing the operator of the child safety seat 151 within the vehicle 141. The vehicle 141 control system 142 presents the challenge and receives a response to the challenge through the vehicle 141 display 148. If the vehicle 141 control system 142 receives an acknowledgement from the operator, the vehicle 141 control system 142 sends a message with this confirmation to the logic module 101 through the interface 131.

If the logic module 101 determines that the operator has not acknowledged the presence of the child safety seat 151 then the logic module 101 loops back to the first decision 171. If the logic module 101 determines that the operator has acknowledged the presence of the child safety seat 151 then the logic module 101 takes a third action 183. The third action 183 entails sending a message through the interface 131 to the vehicle 141 control system 142 requesting that the vehicle 141 engine lock 143 be disabled thereby allowing the vehicle 141 to be started.

The logic module 101 then makes a third decision 173 to determine whether the vehicle 141 key fob 144 is in the vehicle 141 by sending a query through the interface 131 to the vehicle 141 control system 142 requesting the location of the vehicle 141 key fob 144. If the vehicle 141 key fob 144 is in the vehicle 141 the logic module 101 loops back to the third decision 173.

If the vehicle 141 key fob 144 is not in the vehicle 141 then the logic module 101 makes a fourth decision 174 to determine if the child safety seat 151 is occupied by checking the switch actuation position of the seat belt LED 106. If the child safety seat 151 is occupied, the logic module 101 takes a fourth action 184, a fifth action 185, and a sixth action 186. The fourth action 184 entails sending an SMS message through the communication module 102 and the commercially provided and publicly available cellular wireless network 162 to the appropriate authority 161 indicating that an unattended passenger 163 has been left in the vehicle 141. The fifth action 185 entails initiating the operation of the vehicle 141 horn 146 to create an audible alarm indicating that an unattended passenger 163 is in the vehicle 141. The sixth action 186 entails illuminating in a flashing manner the vehicle 141 exterior lights 147 to create a visible alarm indicating that an unattended passenger 163 is in the vehicle 141. The logic module 101 loops back to the fourth decision 174 after the sixth action 186.

If the child safety seat 151 is not occupied, the logic module 101 takes a seventh action 187 and an eighth action 188. The seventh action 187 entails silencing the vehicle 141 horn 146. The eighth action 188 entails extinguishing the vehicle 141 exterior lights 147. After the eighth action 188, the logic module 101 loops back to the first decision 171.

The following definitions were used in this disclosure:

Appropriate Authority: As used in this disclosure, an appropriate authority is a previously determined person or organization that is designated to receive alarm or other notification messages regarding a monitored system or activity.

Automobile: As used in this disclosure, an automobile is a road vehicle that that specializes in carrying passengers and light cargo loads. This definition is specifically intended to include vehicles generally referred to as pickup trucks, vans, minivans, and sport utility vehicles.

Control System: As used in this disclosure, a control system is a first device or system that manages and regulates the behavior or operation of a second device or system.

Diode: As used in this disclosure, a diode is a two terminal semiconductor device that allows current flow in only one direction. The two terminals are called the anode and the cathode. Electric current is allowed to pass from the anode to the cathode.

Display: As used in this disclosure, a display is a surface upon which is presented an image, potentially including, but not limited to, graphic images and text, that is interpretable by an individual viewing the projected image in a meaningful manner.

Domestic Article: As used in this disclosure, a domestic article is an item or object: 1) that is commonly found within a household; or, 2) that is commonly carried by a person. Examples of domestic articles include, but are not limited to, keys and key fobs, personal data devices, glasses, remote controls, or personal storage items such as purses, briefcases,

Interface: As used in this disclosure, an interface is a physical or virtual boundary that separates two different systems across which information is exchanged.

LED: As used in this disclosure, an LED is an acronym for a light emitting diode. A light emitting diode is a diode that is also a light source.

Logic Module: As used in this disclosure, a logic module is a readily and commercially available electrical device that accepts digital and analog inputs, processes the digital and analog inputs according to previously specified logical processes and provides the results of these previously specified logical processes as digital or analog outputs.

Personal Data Device: As used in this disclosure, a personal data device is a handheld device that is used for managing personal information and communication. Examples of personal data device include, but are not limited to, cellular phones, tablets and smart phones.

Sensor: As used in this disclosure, a sensor is a device that receives and responds in a predetermined way to a signal or stimulus. As further used in this disclosure, a threshold sensor is a sensor that generates a signal that indicates whether the signal or stimulus is above or below a given threshold for the signal or stimulus.

SMS: As used in this disclosure, SMS is an abbreviation for short message service. The short message service is a service that is often provided with the cellular services that support personal data devices. Specifically, the SMS allows for the exchange of written messages between personal data devices. The SMS is commonly referred to as text messaging. A common enhancement of SMS is the inclusion of the delivery of multimedia services. This enhanced service is often referred to as Multimedia Media Services, which is abbreviated as MMS.

Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.

Vehicle: As used in this disclosure, a vehicle is a device that is used for transporting passengers, goods, or equipment. The term motorized vehicle refers to a vehicle can move under power provided by an electric motor or an internal combustion engine.

With respect to the above description, it is to be realized that the optimum dimensional relationship for the various components of the invention described above and in FIGS. 1 through 4 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A passenger detection system comprising:
a logic module, a communication module, an anchor sensor, a seat belt sensor, an anchor LED, and a seat belt LED;
wherein the passenger detection system is configured for use with a vehicle;
wherein the vehicle is further defined with a vehicle control system, a vehicle seat belt, a vehicle horn, and vehicle exterior lights;
wherein the logic module, the communication module, the anchor sensor, the seat belt sensor, the anchor LED, and the seat belt LED are electrically interconnected;
wherein the vehicle control system is further defined with a vehicle engine lock, a vehicle key fob, and a vehicle display;
wherein the passenger detection system is configured for use with a child safety seat;
wherein the child safety seat is installed within the vehicle;
wherein the child safety seat is further defined with a child safety seat belt;
wherein the passenger detection system and the vehicle control system are electrically interconnected;
wherein the passenger detection system determines whether the child safety seat is installed within the vehicle; wherein the passenger detection system determines whether the child safety seat is occupied by a passenger;
wherein the passenger detection system requires an operator of the vehicle to physically acknowledge the presence of the child safety seat before the operation of the vehicle is permitted;
wherein the passenger detection system monitors the location of the vehicle key fob relative to the vehicle;
wherein if it is determined that: 1) the vehicle key fob is located at a position external to the vehicle and, that the child safety seat is occupied; then, 2) the passenger detection system activates the vehicle horn; 3) the passenger detection system flashes the vehicle exterior lights; and, 5) the passenger detection system transmits a message to an appropriate authority;
wherein the passenger refers to the occupant of the child safety seat;
wherein the vehicle control system exchanges information with the logic module through an interface;
wherein the vehicle engine lock is a functionality contained within the vehicle control system of the vehicle;
wherein the status of the vehicle engine lock is shared with and changed by the logic module using the interface;
wherein the vehicle key fob is a domestic article that further comprises an electronic device that is monitored by the vehicle control system;
wherein specifically the vehicle control system monitors the location of the vehicle key fob;
wherein the location of the vehicle key fob is shared by the vehicle control system with the logic module using the interface;
wherein the logic module is a programmable electronic device;
wherein the communication module is a wireless electronic communication device that allows the logic module to communicate to an appropriate authority using a wireless technology;
wherein the communication module communicates messages between the logic module and the appropriate authority through a commercially provided and publicly available cellular wireless network;
wherein the anchor sensor is a first switch that is monitored by the logic module;
wherein the anchor sensor is installed in the vehicle seat belt such that the opening and the closing of the vehicle seat belt actuates the first switch;
wherein the logic module senses the actuation position;
wherein the anchor sensor is installed in a vehicle seat belt that is used to anchor the child safety seat into the vehicle;
wherein the seat belt sensor is a second switch that is monitored by the logic module;
wherein the seat belt sensor is installed in the child safety seat belt such that the opening and the closing of the child safety seat belt actuates the second switch;
wherein the logic module senses the actuation position of the second switch;
wherein the anchor LED is a light emitting diode that is controlled by the logic module;
wherein the logic module illuminates the anchor LED when the logic module detects that the vehicle seat belt is latched and in use;
wherein the seat belt LED is a light emitting diode;
wherein the seat belt LED is controlled by the logic module;
wherein the logic module illuminates the seat belt LED when the logic module detects that the child safety seat belt is latched and in use;
wherein the vehicle control system exchanges information with the logic module through an interface;
wherein the vehicle engine lock is a functionality contained within the vehicle control system of the vehicle;
wherein the status of the vehicle engine lock is shared with and changed by the logic module using the interface;
wherein the vehicle key fob is a domestic article that further comprises an electronic device that is monitored by the vehicle control system;
wherein specifically the vehicle control system monitors the location of the vehicle key fob;
wherein the location of the vehicle key fob is shared by the vehicle control system with the logic module using the interface;
wherein the logic module is an electronic device;
wherein the communication module is a wireless electronic communication device that allows the logic module to communicate to an appropriate authority using a wireless technology;
wherein the communication module communicates messages between the logic module and the appropriate authority through a commercially provided and publicly available cellular wireless network;
wherein the anchor sensor is a first switch that is monitored by the logic module;
wherein the anchor sensor is installed in the vehicle seat belt such that the opening and the closing of the vehicle seat belt actuates the first switch;
wherein the logic module senses the actuation position;
wherein the anchor sensor is installed in a vehicle seat belt that is used to anchor the child safety seat into the vehicle;
wherein the seat belt sensor is a second switch that is monitored by the logic module;
wherein the seat belt sensor is installed in the child safety seat belt such that the opening and the closing of the child safety seat belt actuates the second switch;
wherein the logic module senses the actuation position of the second switch;
wherein the anchor LED is a light emitting diode that is controlled by the logic module;
wherein the logic module illuminates the anchor LED when the logic module detects that the vehicle seat belt is latched and in use;
wherein the seat belt LED is a light emitting diode;
wherein the seat belt LED is controlled by the logic module;
wherein the logic module illuminates the seat belt LED when the logic module detects that the child safety seat belt is latched and in use;
wherein the logic module is a programmable device;
wherein the passenger detection system and the vehicle control system are electrically interconnected;
wherein the logic module makes a first decision to determine whether the child safety seat is installed in the vehicle by checking the switch actuation position of the anchor LED;
wherein the logic module makes a second decision to determine whether the operator of the vehicle has acknowledged the presence of the child safety seat in the vehicle;
wherein the logic module then makes a third decision to determine whether the vehicle key fob;
is in the vehicle by sending a message through the interface to the vehicle control system requesting the location of the vehicle key fob;
wherein the logic module makes a fourth decision to determine if the child safety seat is occupied by checking the switch actuation position of the seat belt LED.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. The passenger detection system according to claim 1
wherein the logic module is a programmable device;
wherein the passenger detection system and the vehicle control system are electrically interconnected;
wherein the passenger detection system determines whether the child safety seat is installed within the vehicle; wherein the passenger detection system determines whether the child safety seat is occupied by a passenger;
wherein the passenger detection system requires an operator of the vehicle to physically acknowledge the presence of the child safety seat before the operation of the vehicle is permitted;
wherein the passenger detection system monitors the location of the vehicle key fob relative to the vehicle;
wherein if it is determined that: 1) the vehicle key fob is located at a position external to the vehicle and, that the child safety seat is occupied; then, 2) the passenger detection system activates the vehicle horn; 3) the passenger detection system flashes the vehicle exterior lights; and, 5) the passenger detection system transmits a message to an appropriate authority;
wherein the passenger refers to the occupant of the child safety seat.

16. (canceled)

17. The passenger detection system according to claim 1 16
wherein the logic module sends a message over the interface to the vehicle control system requesting that the vehicle engine lock be disabled thereby allowing the vehicle to be started;
wherein the logic module sends a message over the interface to the vehicle control system requesting that the vehicle engine lock be enabled thereby preventing the vehicle from starting;
wherein the logic module sends a message over the interface to the vehicle control system that requests the location of the vehicle key fob.

18. The passenger detection system according to claim 17 wherein the logic module sends a message through the communication module and the commercially provided and publicly available cellular wireless network to the appropriate authority.

19. The passenger detection system according to claim 18
wherein the logic module initiates the operation of the vehicle horn;
wherein the logic module illuminates in a flashing manner the vehicle exterior lights;
wherein the logic module silences the vehicle horn;
wherein the logic module extinguishes the vehicle exterior lights.

20. The passenger detection system according to claim 19
wherein the passenger detection system determines whether the child safety seat is installed within the vehicle;
wherein the passenger detection system determines whether the child safety seat is occupied by a passenger;
wherein the passenger detection system requires an operator of the vehicle to physically acknowledge the presence of the child safety seat before the operation of the vehicle is permitted;
wherein the passenger detection system monitors the location of the vehicle key fob relative to the vehicle;
wherein if it is determined that: 1) the vehicle key fob is located at a position external to the vehicle and, that the child safety seat is occupied; then, 2) the passenger detection system activates the vehicle horn; 3) the passenger detection system flashes the vehicle exterior lights; and, 5) the passenger detection system transmits a message to an appropriate authority.
